(19) United States
(12) Patent Application Publication
(10) Pub. No.: US 2012/0089535 A1
(43) Pub. Date: Apr. 12, 2012

(54) FINANCIAL PLANNING METHODS AND APPARATUS

(76) Inventor: ASHRAF HEBELA, Oakland, CA (US)

(21) Appl. No.: 12/901,442

(22) Filed: Oct. 8, 2010

(51) Int. Cl. G06Q 40/00

(52) U.S. Cl. 705/36 R; 705/35

(57) ABSTRACT

A financial planning solution for consumers includes online software for consumers that may provide a comprehensive financial plan, including features such as planning for budgets, home insurance, auto insurance, life insurance, long term disability, short term disability, umbrella insurance, asset allocation, financial goals, estates, education, pre-retirement, in-retirement, risk profile, emergency fund/liquidity, net worth, stock option, unemployment, and the like.

### BACKGROUND OF THE INVENTION

The present invention relates to financial planning methods and apparatus and, more particularly, to a high-quality comprehensive financial plan using online software.

Consumers current do not have a cost-effective (for example, a product or service that may cost at or below $100 annually) option when it comes to getting high-quality, comprehensive financial plans.

There are other financial planning solutions presently available, including the following categories: 1) Financial planning firms. These are primarily services-based businesses. While some may use third party software to help them provide consumers with financial plans, the software they use is typically tailored to specific financial planning functions (e.g., asset allocation, product selection, and the like) versus providing a unified financial planning system that covers all aspects of a comprehensive financial plan. These services either charge consumers a fee based on a percentage of assets under management, an hourly or annual rate, or charge a fee based on the type of plan a consumer wants (e.g., retirement plan, education plan, insurance plan). The costs of these plans typically end up costing thousands of dollars. 2) Enterprise level financial planning software. These software applications are usually provided on-premise and usually not online. They cost hundreds of thousands of dollars to license and are typically sold to businesses such as investment banks, retail banks and financial planning firms. As such, they are not sold to actual consumers and are cost prohibitive for a consumer to purchase. They also are not intuitive, so typically they come with comprehensive and costly training and support material to make it easier to understand by businesses that purchase them. 3) Online consumer-based personal financial finance products. These products tend to either be income and expense tracking products that primarily focus on budget planning. However, budget planning is but one of many other aspects of a comprehensive financial plan.

As can be seen, there is a need for a financial planning software application and methods for providing comprehensive financial plans to consumers.

### SUMMARY OF THE INVENTION

In one aspect of the present invention, a financial planning application comprises an input module for gathering data from a user; an analyze module for analyzing the data; an implement module for providing tasks and alerts to the user based on the data analyzed; and an educate module for providing educational materials to the user.

In another aspect of the present invention, a method for providing a consumer a comprehensive financial plan comprises gathering data from users in an online environment; calculating a financial health score for each of the users; allowing the users to compare their individual score to an average and median score of all of the users; and providing a list of tasks and alerts to the users, the tasks and alerts customized for each user depending on the data gathered from each user.

In a further aspect of the present invention, a computer-implemented method, written as a programmable code, stored on a computer readable medium, and adapted to provide a financial planning system, comprises retrieving data from users of the financial planning system; calculating a financial health score for each of the users; comparing the users' individual scores to an average and median score of all of the users; and providing a list of tasks and alerts to the users, the tasks and alerts customized for each user depending on the data gathered from each user.

These and other features, aspects and advantages of the present invention will become better understood with reference to the following drawings, description and claims.

### BRIEF DESCRIPTION OF THE DRAWINGS

FIG. 1 is a representation of a user's computer screen showing an example of an input step according to an embodiment of the present invention;

FIG. 2 is a representation of a user's computer screen showing an example of the conclusion of the input step, according to an embodiment of the present invention;

FIG. 3 is a representation of a user's computer screen showing an example of an analyze step according to an embodiment of the present invention;

FIG. 4 is a representation of a user's computer screen showing an example of an implement step according to an embodiment of the present invention;

FIG. 5 is a representation of a user's computer screen showing an example of an educate step according to an embodiment of the present invention;

FIG. 6 is a representation of a user's computer screen showing another example of an educate step according to an embodiment of the present invention; and

FIGS. 7A and 7B show a flow chart describing an overview of a financial planning system according to an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a financial planning solution for consumers. The financial planning solution includes online software for consumers that may provide a comprehensive financial plan, including features such as planning for budgets, home insurance, auto insurance, life insurance, long term disability, short term disability, umbrella insurance, asset allocation, financial goals, estates, education, pre-retirement, in-retirement, risk profile, emergency fund/liquidity, net worth, stock option, unemployment, and the like. The financial planning solution may cost much less than traditional financial planning options, typically costing $100 or less.

The financial planning solution of the present invention may include the following features: A) Intuitive. The financial planning solution of the present invention may be designed by asking a user questions in an intuitive fashion and allowing the consumer to submit their data to a proprietary financial planning engine that returns a consumer's “financial planning health” along with specific, detailed, personalized, categorized and prioritized action items to help a consumer understand their strengths and weaknesses and implement recommendations. B) Informative. The financial planning solution of the present invention may provide detailed definitions and examples of many of the online data gathering step information it asks consumers to fill out, making it a financial educational system as well. C) Interactive. The financial planning solution of the present invention may use the user's answers to the online data gathering steps to impact the level of personalization, quantitative and qualitative recommendations returned by the financial planning algorithms and software. D) Comparative. The financial planning solution of the present invention may allow users to compare their data gathering step input (expenses, income, objectives, and the like) to other consumers of the present invention by providing client average and client median results for specific data as benchmarks. E) Educational. The financial planning solution of the present invention may include a library of online financial calculators and a search portal with unique underlying calculations and content.

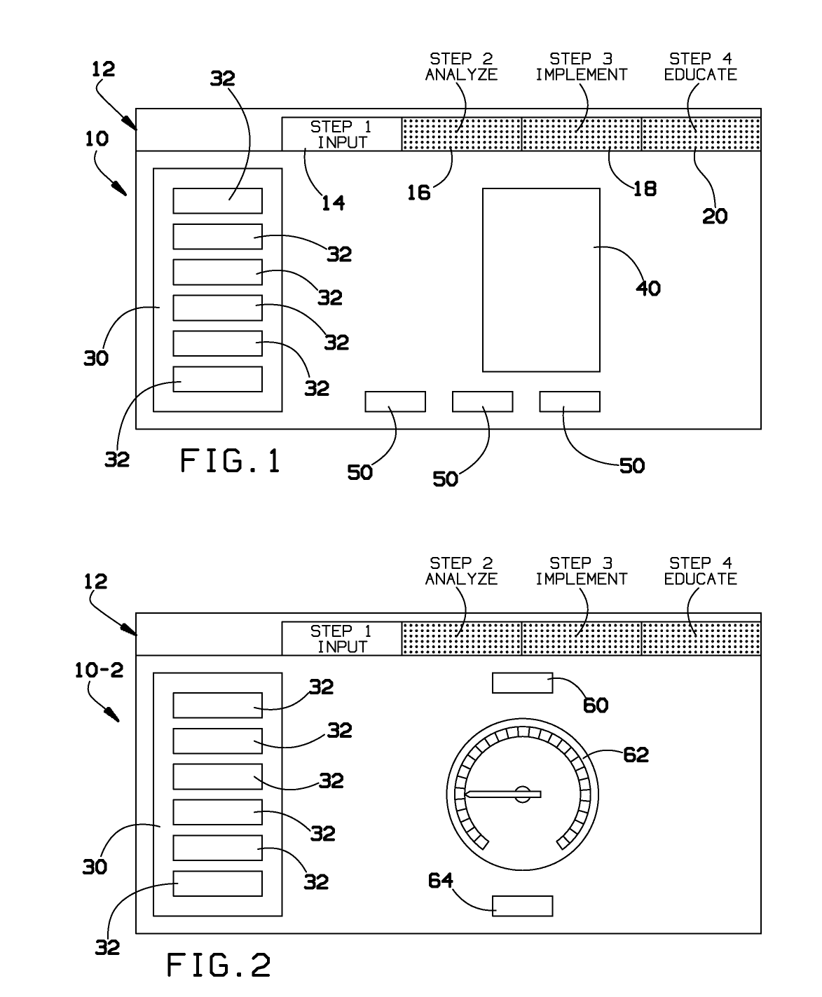

Referring now to FIG. 1, in a data gathering step 14 (also referred to as Step 1: Input, or simply an input step), a screen 10 may be provided to a user. In the screen 10 (as well as most, typically all of the screens of the system), a top portion 12 of the screen may include a header with each of the four steps 14, 16, 18, 20. The steps may be labeled as Step 1: Input, Step 2: Analyze, Step 3: Implement and Step 4: Educate. Clicking on the taps in the top portion of the screen 10 may allow a user to jump between steps.

On a portion of the screen may be disposed a selection box 30. The selection box 30 may include various items that a user may select in the particular step they are completing. In FIG. 1, the selection box 30 may include steps 32 such as profile summary, current children, stock options & stock plans, current fixed assets & loans, current net worth, income, expenses, risk profile, ValueCircle™, fixed asset objectives, future children, future education planning, retirement planning, incremental income & expenses, basic insurance, life insurance, long term disability insurance, estate planning, unemployment planning, optional modules (which a user may purchase or may be provided by the software provider), and submit for review. The ValueCircle™ may be a module where each user may input various financial goals and objectives and answer questions about their financial philosophy. These values may be analyzed and compared, as discussed below.

Once each step 32 is completed, an indicator, such as a checkmark, may appear next to the step. For example, for the step 32 of profile summary, a user may be provided with an data input box 40, where a user may provide profile summary data, such as name, address, gender, date of birth, and the like. In this screen and other screens, some data fields may have informational content about that field. A user may roll over the indicator of informational content to see the information therewithin. As data is entered, control buttons 50 may be present on the screen. The control buttons 50 may include buttons for going back, saving data, going forward, deleting information, clearing the fields on the screen, and the like.

Referring to FIG. 2, a screen 10-2 may have the same top portion 12 as FIG. 1. This screen 10-2 may appear once the user clicks the step 32 that the data is ready for review (“submit for review”). This screen 10-2 may provide a user with a financial health score 60 and may show a graph 62 visually depicting this health score. A button 64 may appear on the screen 10-2 to allow a person to view their alerts, which will be described below regarding step 3: implement.

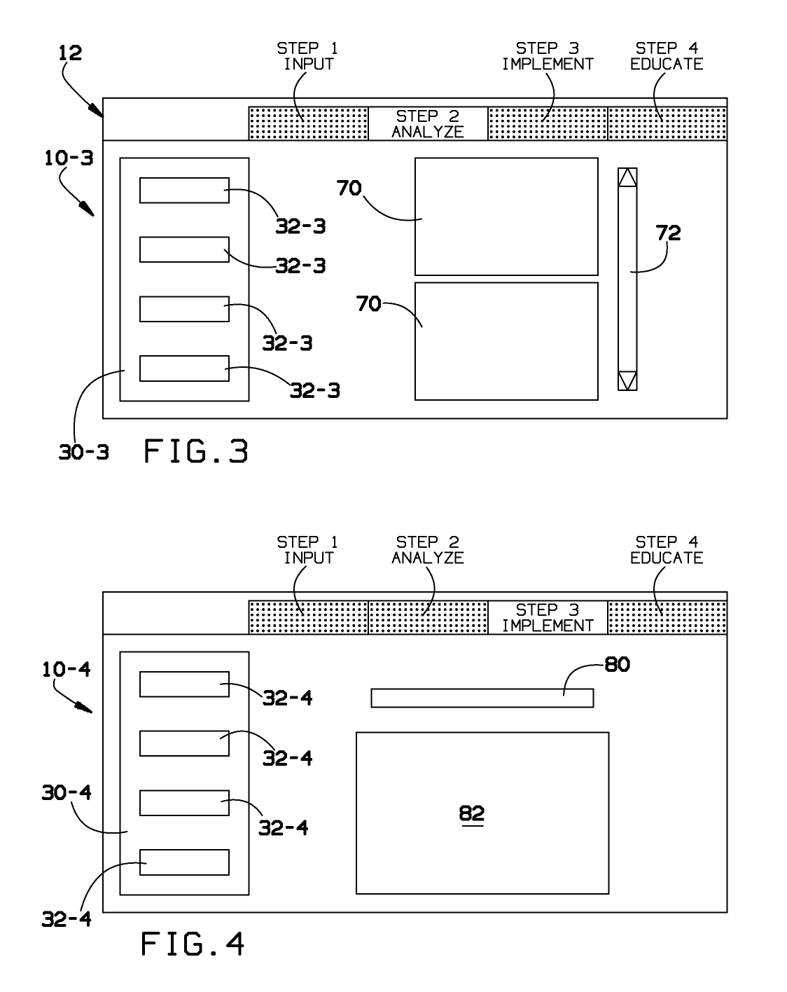

Referring to FIG. 3, a screen 10-3 may have the same top portion 12 as FIG. 1, except that Step 2: Analyze may be highlighted. In the analyze screen 10-3, a selection box 30-3 may include a number of selections 32-3 available to a user. The selections 32-3 may include options called “compare my profile”, “compare my expenses”, “compare my objectives”, and “compare my values”. These selections 32-3 may compare various elements of the user's data to benchmark data as well as to averages and medians of all user's of the system and/or against national benchmarks/statistics. In addition, the user may have access to not only national averages, but also regional averages and the like. The analyzed data may appear, for example, as graphs 70 on the screen. A scroll bar 72 may be provided to scroll when multiple graphs are present. A user may be able to click on data in the graphs 70 to return to the input step 14, showing where the data from that particular analysis was obtained.

Referring to FIG. 4, in the implement step 18, a user may be presented with a screen 10-4 having a selection box 30-4 showing a number of selections 32-4 for the user. The selections 32-4 may include “view alerts & tasks”, “add alerts and tasks”, “analyze your list”, and an option to upgrade or add additional components and/or modules. Also on the screen 10-4, a search box 80 and a chart 82 of alerts and/or tasks may be presented. The search box 80 may allow the user to find a particular task by various search categories. These categories may include options such as to whom the task is assigned, the priority of the task and the status of the task.

The chart 82 may include columns for the alert/task, the module the task/alert belongs, the priority of the task/alert, to whom the task/alert is assigned, and the status of the task/alert. The alert/tasks may include items such as lack of insurance for members of the household, lack of savings, alignment of financial values between family members, and the like. A user may have access to reporting functionality, where the user can print their task reports and hence have a hardcopy report that provides summary and/or details of all their open tasks, by category.

Referring to FIG. 5, in the educate step 20, a user may be presented with a screen 10-5 having a selection box 30-5 showing a number of selections 32-5 for the user. The selections 32-5 may include “calculators”, “search” and “upcoming features”, for example. On the calculators page, as shown in FIG. 5, a user may be provided a drop down box 90 from which a user may select one of several financial calculators. Various calculators may be available, depending on the user's subscription level. For example, a user may select a mortgage calculator. Once the calculator is selected, an input box 92 may appear into which data may be entered. Some of this data may be imported from that entered in the data gathering step 14. The input box 92 may include graphical sliders that may allow the user to change certain variables in the calculator. An output box 94 may provide various forms of analysis as a result of the selected calculator, such as a monthly mortgage payment, alternate payment amounts/schedules, and the like.

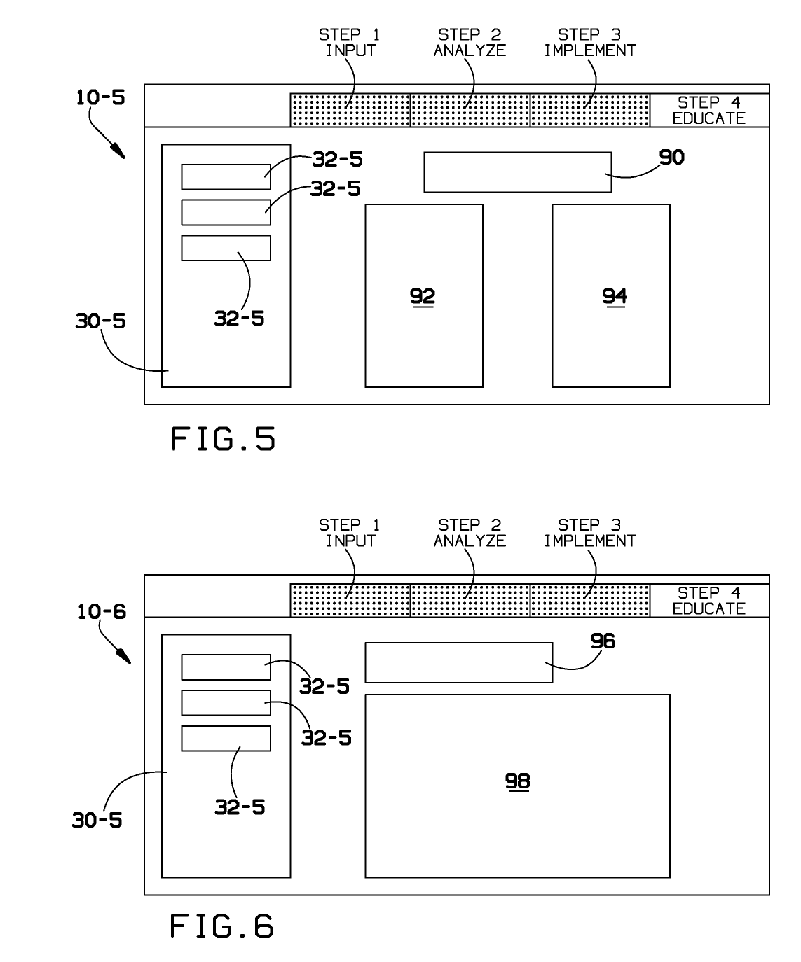

Referring to FIG. 6, still in the educate step 20, the user may select to search from the selections 32-5. A search screen 10-6 may include a text entry box 96 and a search results box 98. The user may click on the search results to view more details on that particular result.

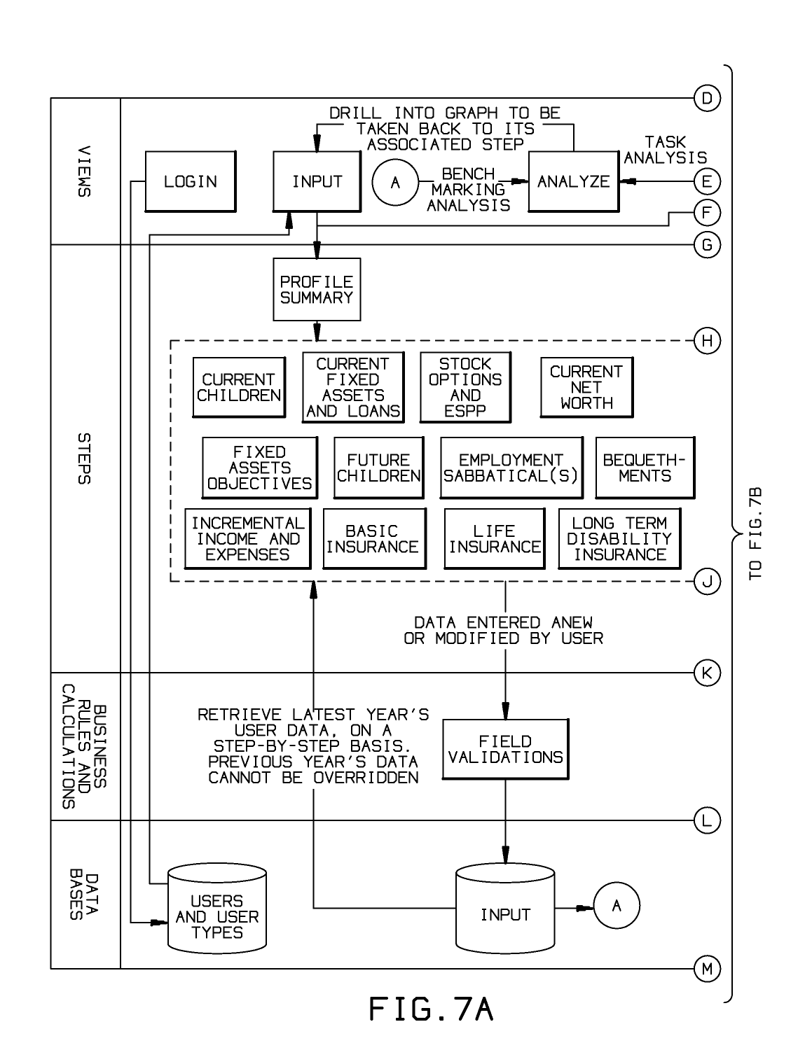

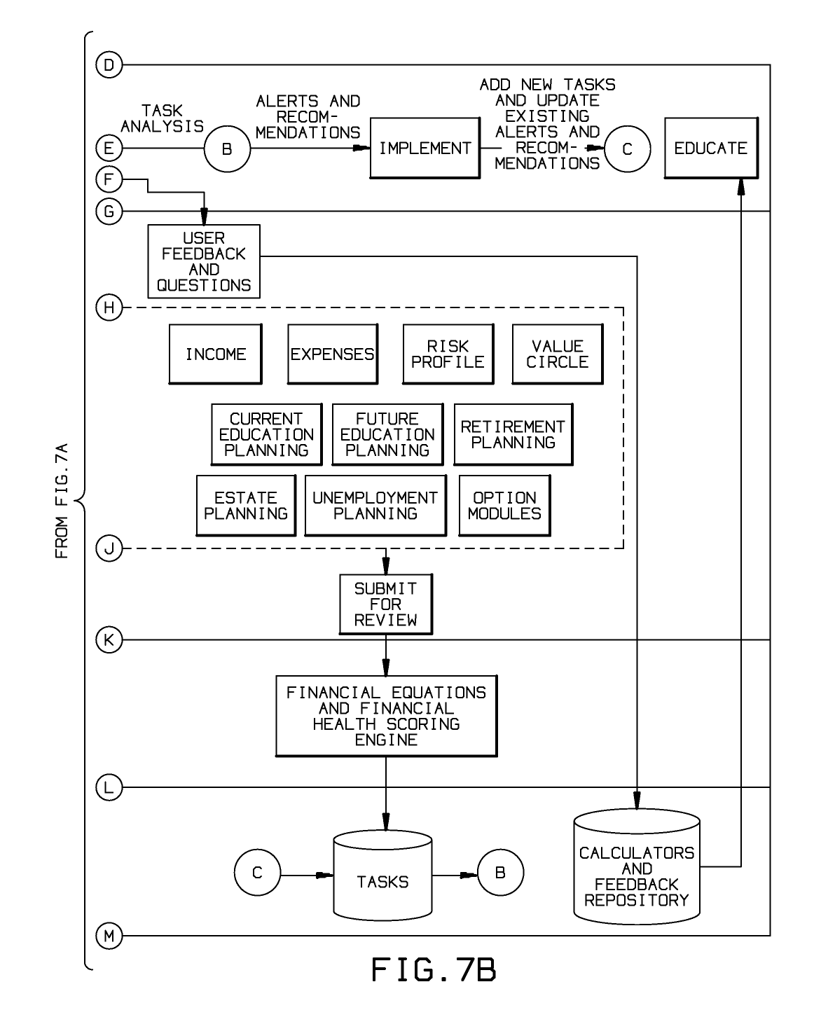

Referring to FIGS. 7A and 7B, there is shown a flow chart describing the overall application described above. The views described above are shown, as well as exemplary data gathering steps. As can be seen, several databases may be maintained by the application, including a database of users and user types, an input database holding information about the users of the system, a tasks database for each user, and a database containing the calculators and feedback information. The databases may be relational databases, wherein data in one database may be linked, as appropriate, to data in other databases.

It should be understood, of course, that the foregoing relates to exemplary embodiments of the invention and that modifications may be made without departing from the spirit and scope of the invention as set forth in the following claims.

What is claimed is:

1. A financial planning application comprising:
an input module for gathering data from a user;
an analyze module for analyzing the data;
an implement module for providing tasks and alerts to the user based on the data analyzed; and
an educate module for providing educational materials to the user.

2. The application of claim 1, wherein the application provides a financial health score for the user.

3. The application of claim 1, wherein the analyze module is adapted to compare the data of the user to data of other users of the application.

4. The application of claim 1, wherein the tasks and alerts are prioritized for the user.

5. The application of claim 1, wherein the application is provided in an online environment.

6. A method for providing a consumer a comprehensive financial plan, the method comprising:
gathering data from users in an online environment;
calculating a financial health score for each of the users;
allowing the users to compare their individual score to an average and median score of all of the users; and
providing a list of tasks and alerts to the users, the tasks and alerts customized for each user depending on the data gathered from each user.

7. The method of claim 6, wherein the step of gathering data includes gathering data about the users' current children, current education planning, stock options & stock plans, current fixed assets & loans, current net worth, income, expenses, risk profile, financial values, fixed asset objectives, future children, employment sabbatical(s), bequeathment(s), future education planning, retirement planning, incremental income & expenses, basic insurance, life insurance, long term disability insurance, estate planning, unemployment planning.

8. The method of claim 6, further comprising providing help icons, wherein the users point at the help icons to receive help on a subject adjacent to the help icon pointed to.

9. A computer-implemented method, written as a programmable code, stored on a computer readable medium, and adapted to provide a financial planning system, comprising:
retrieving data from users of the financial planning system;
calculating a financial health score for each of the users;
comparing the users' individual scores to an average and median score of all of the users; and
providing a list of tasks and alerts to the users, the tasks and alerts customized for each user depending on the data gathered from each user.
